(19) United States
(12) Patent Application Publication
(10) Pub. No.: US 2008/0083497 A1
(43) Pub. Date: Apr. 10, 2008

(54) Process for producing a reinforced acoustically resistive layer, resistive layer thus obtained and panel using such a layer

(75) Inventors: Pascal Dublineau, Saint Sauveur De Landermont (FR); Michel Buge, Saint Sebastien Sur Loire (FR); Alain Porte, Colomiers (FR)

Correspondence Address: YOUNG & THOMPSON, 745 SOUTH 23RD STREET, 2ND FLOOR, ARLINGTON, VA, 22202, US

(73) Assignee: AIRBUS FRANCE, Toulouse Cedex 03 (FR)

(21) Appl. No.: 11/987,246

(22) Filed: Nov. 28, 2007

Related U.S. Application Data
(63) Continuation of application No. 10/173,095, filed on Jun. 18, 2002, now abandoned.

(30) Foreign Application Priority Data
Jun. 19, 2001 (FR) 01 08036

(51) Int. Cl. B32B 37/14

(52) U.S. Cl. 156/307.3; 156/307.7

(57) ABSTRACT

The object of the invention is a process for the production of a reinforced acoustically resistive layer, in which there is produced a layer of structural reinforcement from fibers pre-impregnated with a thermosetting or thermoplastic resin, said layer having a given quantity of open surface relative to the acoustic waves to be handled, there is associated with said reinforcing layer a metallic acoustic cloth whose mesh is suitable for the quantity of open surface of said structural layer, and the polymerization or consolidation of said resins under pressure and temperature suitable for the resins used, is carried out, characterized in that there is associated with the impregnation resin for the fibers a component (2a) adapted for macromolecular interpenetration with said resin during the polymerization or consolidation so as to ensure for the reinforcing layer (2) improved mechanical and adhesive properties for the metallic cloth. Application to the production of acoustic panels.

This application is a continuation of application Ser. No. 10/173,095, filed Jun. 18, 2002.

The present invention relates to a process for producing a resistive layer for an acoustic panel, particularly for the production of nacelles of aircraft jet engines and more generally all conduits requiring soundproof panels.

The invention also relates to the acoustically resistive layer thus obtained and all acoustically absorbent panels using this layer in combination with other layers.

There are known resistive layers more or less permeable to air, which permit very significant attenuation of sound waves. These layers are combined with cellular structures of the honeycomb type to constitute quarter wave resonators attached to a total reflector.

The resistive layers play the role of dissipating acoustic energy by transforming it into heat thanks to the viscous effects that arise during circulation of the waves. They generally comprise at least one acoustically damping cloth and a reinforcing material.

Such layers, as well as panels made from these layers, are described in French patent application No. 2 767 411 in the name of the present applicant. In this application, it is provided to reinforce the mechanical resistance of a metallic or compound sound damping cloth by adding a layer of structural reinforcing material, connected to this resistive layer. In this application, the reinforcing filaments are of an adjustable surface opening quantity and secured to said cloth.

The acoustic cloth is essentially selected as a function of its high capacity to render acoustic processing linear and to trap the acoustic waves in the Helmholtz cells formed by the cellular structure. This cloth has a suitable mesh but its thickness is necessarily very small, of the order of 1 to 2 tenths of a millimeter, to give an order of magnitude.

In the case of the choice of a metallic sound dampening cloth, recourse is had to a stainless grid cloth of the type of those sold under the mark GANTOIS.

Such cloths have the advantage of being available on the market and even with very small thicknesses as indicated, the mechanical resistance remains great relative to a cloth of synthetic material.

Thus, in the case of aircraft jet engine nacelles, the surface of the resistive layer is in direct contact with solid particles such as grains of sand and small stones which give rise to erosive phenomena or else pieces of ice or birds that may be sucked in, which, at the speed, give rise to mechanical damage.

The metallic cloth also has the advantage of conducting lightning.

A first drawback is its weight relative to synthetic materials, which also explains its very small thickness so as to limit the added weight.

Another important drawback is the connection between this cloth and the reinforcing material, which is a perforated plate of light metal such as aluminum, a shape molded composite panel, or filaments (namely strips of filaments, strands or braids of filaments, according to the cross-section).

This connection is very important because in the case in which the cloth is disposed on the outside, on the side of the circulating airflow, it is necessary to avoid any delamination of the cloth relative to its support, particularly in the case of mechanical rupturing shock arising accidentally from a foreign body.

Thus, if delamination takes place, pieces of cloth of the greater surface area can tear off, which would be impermissible.

Moreover, another problem is that of connecting the cloth to its support whilst leaving the meshes open, because any decrease in the quantity of holes (quantity of open surface) contributes to decreasing the capacity for acoustic damping of the resistive layer.

In the case in which the acoustically damping cloth is interposed between the structural reinforcing layer and the honeycomb structure, as described in French patent application No. 99 16447 in the name of the present applicant, the problem of connection is also very great. In this case, it is necessary that the connection between the honeycomb cellular structure and the structural reinforcing layer takes place on opposite sides of the acoustically damping cloth, even in part through the meshes, but always without closing these meshes.

The techniques used in the prior art consist in having recourse to composite materials comprising thermosetting resins, but controlling this family of resins is difficult. Moreover, the resin contained in the composite material does not have good adhesion characteristics. Thus, the connection between the composite material and the acoustically damping cloth has less resistance than the intrinsic resistance of the cloth itself, which is to say the filaments which comprise it, so that the region of adhesion remains a point of fragility of the resistive layer in its assembly.

Moreover, once polymerized, said thermosetting resin is fragile, because of its weak mechanical characteristics. If the composite materials comprising thermosetting resins have undeniable qualities, their weak mechanical characteristics are not sufficient for the use which arises in the aeronautic field.

In French patent application No. 99 16449 in the name of the application, it was sought to solve the mentioned problems by a process of production of an acoustically resistive layer which comprises the following steps:
producing a structural reinforcing layer by using thermoplastic resins, this layer having a given open surface area relative to the acoustic waves to be processed,
connecting a metallic acoustic cloth whose mesh is suitable to the surface area of the structural layer, and
ensuring the consolidation of the thermoplastic resins under pressure and at high temperature.

The invention described in said application thus provides a process for production of a resistive layer so as to produce a connection of its constituents, in different modified arrangements, which is satisfactory by having the capacity for solidarization such that, mechanically for example, the resistance of the interface connection of the structural and acoustic components is greater than the intrinsic strength of the acoustically damping cloth, thereby forming a monolithic assembly.

The thermostable thermoplastic resins, such as those of the family of polyetherimides (PEI), the polyetheretherketones (PEEK), the polyphenylenesulfones (PPS), the polyamides (PA) and polyethyleneterephthalate (PET), are well known for their adherence properties. Nevertheless, the qualities and properties of each of these resins do not render all of them of interest to use. For example, the resins of the PEI family have acceptable mechanical resistance for a very high quality of adherence. Moreover, their use is easy at moderate cost. On the contrary, the resins of the PEEK family have lesser qualities of adherence for a mechanical resistance comparable to the resins of the PEI family. Unfortunately, their price remains discouraging.

In the case in which the damping cloth is a cloth made of stainless steel, it is important that the resistive layer have very good properties of adherence, to avoid problems of delamination due to inevitable degradations of an aircraft in service. Thus, it is known to those skilled in the art that stainless steel is a material difficult to cement. This drawback is all the more troublesome when it is necessary to repair a small damaged portion of the nacelle, beyond a suitable environment.

The cementing on a stainless steel cloth is thus delicate and not completely mastered, whether using technology of thermosetting resins or the technology of thermoplastic resins.

As a result of the techniques given above, the layer of structural reinforcement remains a weak point of the acoustic panel, even if solutions are sought for improving this state of affairs.

The present invention has precisely for its object to overcome the mentioned technical drawbacks.

To this end, the invention has for its object a process for producing a reinforced acoustically resistive layer, in which:
there is produced a structural reinforcing layer from fibers pre-impregnated with a thermosetting or thermoplastic resin, said layer having a given open surface quantity relative to the sound waves to be processed,
there is associated with this reinforcing layer a metallic acoustic cloth whose mesh is adapted to the open surface quantity of said structural layer, and
the polymerization or consolidation of said resins is conducted under a suitable pressure and temperature for the resins used,
   characterized in that the impregnation resin of the fibers is associated with a component adapted for a macromolecular interpenetration with said resin during polymerization or consolidation, so as to ensure that the reinforcing layer has improved mechanical and adhesive properties to the metallic cloth.

When the structural reinforcing layer uses fibers pre-impregnated with a thermosetting resin, said component adapted to reinforce the mechanical and adhesive properties is an adhesive material with elastic properties.

When the structural reinforcing layer uses fibers pre-impregnated with a thermoplastic resin, particularly a thermoplastic thermostable resin selected from the group of polyetheretherketones, said component is a thermoplastic resin selected from the family of polyetherimides.

According to a first embodiment of practice of the invention and no matter what the type of impregnation resin for the fibers of the structural reinforcing layer, said pre-impregnated fibers are first subjected to immersion in a bath containing said component for reinforcing the mechanical and adhesive properties, to be then emplaced in a mold by winding or draping in a known manner.

If said impregnation resin is a thermosetting resin, it is advantageous in this case to carry out before immersion a pre-polymerization of the pre-impregnated fibers under suitable conditions such that the composite material used will be more rigid than in the raw state and hence easier to manipulate during production of the acoustically resistive layer.

Instead of immersion, the thermosetting or thermoplastic resin can be placed in contact with said component for reinforcing the properties particularly of adherence, in the course of deposition on a mold of the components of the acoustically resistive layer, said reinforcing component being in the form of one or several films emplaced in different ways which will be described later.

The invention is application more particularly to the production of an acoustically resistant layer with two components, structural and acoustic, of which the acoustic component is constituted by a stainless steel cloth.

The process of the invention thus permits, in the case of the use of such a cloth, both making up the lack of adhesive properties and the lack of mechanical properties of the resin used, by ensuring a cementing that is resistant and of very high quality, between the structural reinforcing layer and the stainless acoustic cloth, and by ensuring a reinforcement of the mechanical strength of the structural reinforcing layer. In this case, the resistance of the interfacial connection of the structural and acoustic layers is greater than the intrinsic strength of the acoustic damping cloth, thereby forming a monolithic assembly. Said resistance is thus greater than the resistance of the component material used in prior art techniques, both those using thermosetting resins and those using thermoplastic resins, the layer thus obtained being thus able to resist shocks and forces to which it is subjected.

There will now be described in greater detail embodiments of the process of the invention referring to the accompanying drawings, in which:

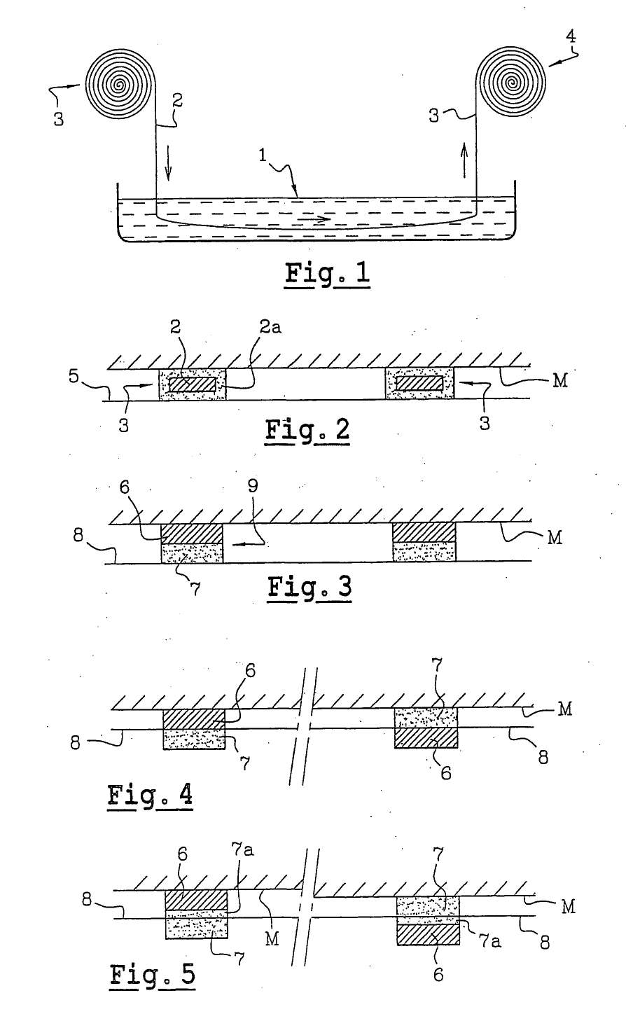

FIG. 1 is a schematic illustration of the immersion of a composite material in a coating bath, prior to its use for the production of an acoustically resistive layer according to the invention;

FIG. 2 shows the production of an acoustically resistive layer with the help of the composite material of FIG. 1;

FIGS. 3 to 5 show various embodiments of the acoustically resistive layers using the association of a resin for the impregnation of fibers of the PEEK type with a resin of the PEI type;

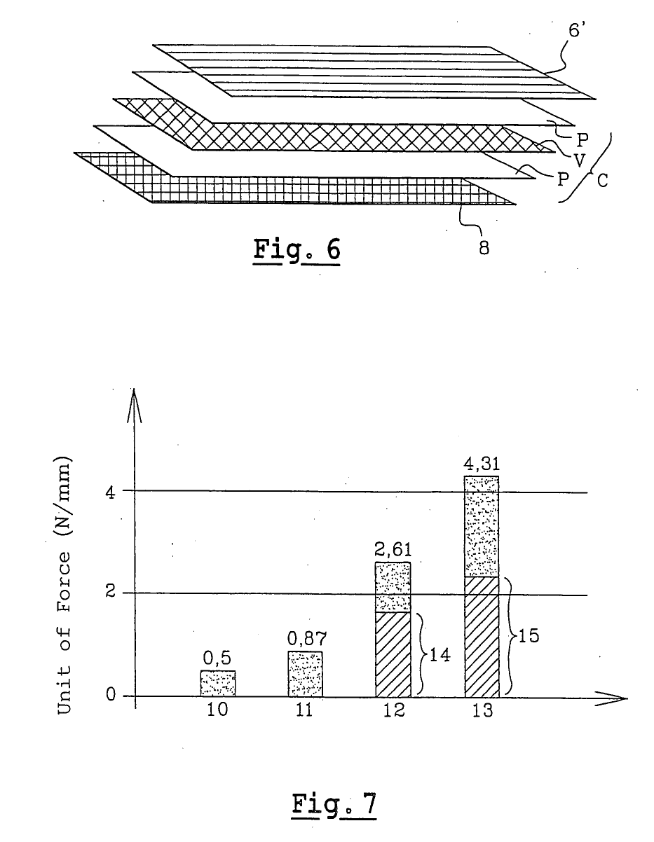

FIG. 6 shows a modified embodiment of an acoustically resistive layer according to the invention, and

FIG. 7 is a diagram showing the properties of mechanical resistance of various acoustically resistive layers according to the invention, in comparison with conventional layers.

In FIG. 1, there is shown at 1a coating bath by continuous immersion of a composite material formed by fibers for example of carbon, glass or KEVLAR®, pre-impregnated with a thermosetting resin such as an epoxyde resin. The fibers are in the form of filaments, strands, roving or slubbing of filaments of variable cross-section.

In FIG. 1, the composite material is formed by a filament 2 wound on a reel 3. The filament 2 passes through a bath 1 of an adhesive material having elastic properties, for example a nitrile-phenolic cement. After immersion, the filament 3 is rewound at 4.

The filament 3 is shown in cross-section in FIG. 2 and comprises the filament of composite material 2 clad with a sheath 2a of adherent material from the path 1.

For easier use of the composite material 2, this latter will be, prior to immersion, subjected to pre-polymerization, for example at a temperature of 150° C. for about 15 minutes, the temperature and duration being a function of the speed of polymerization, itself a function of the impregnation process (drying means, running speed, etc. . . . ). The composite material 2 is thus more rigid than in the raw condition and hence easier to manipulate. Moreover, the resin contained in the composite material being already pre-polymerized, it is not dissolved by the solvents in the bath 1.

The composite material 3 thus clad is then used to produce an acoustically resistive layer of two components, one a reinforcing structure, the other acoustic, constituted by a metal cloth indicated at 5 in FIG. 2.

To this end, and according to conventional techniques of winding or draping, there is emplaced on a mold indicated at M in FIG. 2, the filaments 3 with a predetermined spacing between them defining an amount of open surface of the structural reinforcing layer constituted by the deposit of filaments 3, given relative to the acoustic waves to be handled.

The metallic cloth 5, constituted by stainless steel for example, is then deposited on the filaments 3. It is of course possible to reverse the depositions, the cloth 5 being first emplaced on the mold M.

Next comes the polymerization of the assembly in the conventional manner as to pressures and temperatures which are suitable for the resins used.

The adherent cladding material 2a penetrates into the composite material 2 by interpenetration by polymerization and adheres to the metallic cloth 5. This process ensures a very resistant connection between the fibers of composite material 2 and the acoustic metal cloth 5, as well as improved mechanical properties.

It thus was discovered, in an unexpected manner, that when acoustic damping panels of the type mentioned above, are made with a honeycomb core flanked, on the one side, by a total reflector and, on the other side, by an acoustically resistive layer with two components according to the invention, that the presence of elastomer in the composition of the coating bath 1 leads to an elastic damping effect permitting absorbing the forces generated by shocks on the panel or during the use of these latter (torsion, flexure, etc. . . . ), these forces being absorbed in a manner that could not be achieved by the thermosetting resin because of its fragility. This is as much the properties of adherence of the nitrile-phenolic cement which are enjoyed, as its elastic properties.

The process of the invention thus permits the production of an acoustically resistive layer with two components constituting one monolithic member ensuring the transfer of aerodynamic and inertial forces as well as those that may be associated with the envisaged use. For example, in the case of jet engine nacelles, it is also necessary to be able to receive and transfer the forces connected with maintenance toward the structural nacelle/motor connections.

Instead of carrying out the preliminary step described above, of coating the composite material before production of an acoustic damping panel, it is of course possible to produce the panel in a sequential manner according to the invention, which is to say to associate the adhesive component with elastic properties, with the thermosetting resin of the composite material in the course of production of the panel.

To this end, there are carried out the following steps:
deposition for example of carbon fibers pre-impregnated with an epoxyde resin, on a mold,
pre-polymerization of the epoxyde resin,
deposition of a film for example of nitrile-phenolic cement,
deposition of the metallic cloth for example of stainless steel,
final polymerization.

Such an embodiment gives rise to no particular problem, the deposition process of the filaments and of the adherence film, as well as the operations of pre-polymerization and final polyermization, being processes that are conventional per se.

Other adhesive materials than nitrile-phenolic cement, having elastic properties, can be used in the scope of the invention.

The process of the invention can also be used with composite materials constituted by fibers, particularly unidirectional, pre-impregnated with a thermostable, thermoplastic resin, for example of one of the types mentioned in the preamble of the present description.

It is known that these resins, despite their undeniable qualities, have several drawbacks.

For example, the thermoplastic resin PEEK which is used in the field of the invention because its qualities of ease of use and mechanical resistance are desirable, nevertheless has properties of adherence which prove to be insufficient when it is applied to a metallic cloth, in particular a cloth of stainless steel.

On the contrary, the thermoplastic resin PEI which has very good qualities of adherence, has worse mechanical characteristics. Moreover, its mechanical properties degrade when it is in contact with a so-called “aggressive” fluid. These fluids are widely used in the field of aeronautics, for example in the form of hydraulic liquid. In the case of hydraulic loss, the acoustic panel and its components are thus subjected to the flow of the aggressive fluid. Under these circumstances, the PEI resin loses about 50% of its characteristics.

Thus, the use of PEEK resin associated with PEI resin would not see to be advantageous given only the quality of adherence of the PEI resin.

However, the association, according to the invention, of the PEI resin with the PEEK resin in the course of production of an acoustically resistive layer with a double structural component of composite and acoustic material of metal cloth, particularly stainless steel, has in a surprising manner permitted obtaining a connection between the metallic cloth and the composite material about eight times more resistant than a connection produced with a thermosetting resin and about five times more resistant than a connection produced with a composite thermoplastic material using only PEI resin.

FIGS. 3 to 5 show various embodiments of the practice of the process of the invention, in the case of a composite material constituted by unidirectional filaments, for example of carbon, glass or KEVLAR®, pre-impregnated with a thermostable thermoplastic resin, more precisely a PEEK resin.

At the outset, it is to be noted that the technique shown in FIG. 1 can be used, the composite material being, before its deposition on a mold, subjected to continuous immersion in a bath containing a solution of PEI resin in a suitable solvent. After evaporation of the solvent, there remains on the surface of the fibers or filaments pre-impregnated with PEEK resin, a film of PEI resin. The composite material is then put in place as well as the acoustic metallic cloth, as shown in FIG. 2 for example.

According to FIG. 3, there can be deposited on a mold M by winding or draping, the composite material 6 constituted by a layer of filaments pre-impregnated with PEEK resin, then a film 7 of PEI resin, deposited on the surface of the composite material 6 for example by a hot calandering technique, at a temperature of the order 270° C. for example, which permits obtaining a very homogenous cladding of the PEEK resin.

The acoustic metallic cloth 8 is then deposited on the PEI resin 7, then the assembly is subjected to final conventional consolidation.

During melting, there is macromolecular interpenetration between the PEEK resin (6) and the PEI resin 7 and cementing by polar affinity between the metallic cloth 8 and the PEI resin at the film 7/metallic cloth 8 interface, which explains the very good qualities of adhesion of the assembly 9.

It is also possible to interleave the metallic cloth 8 between the layer (6) of PEEK carbon filaments and the film 7 of PEI resin, provided the layer 6 is first deposited on the mold M (left part of FIG. 4) or in the second place (right portion).

As a modification, there can be added, for example by pinch coating, a second film 7a of PEI resin between the metallic cloth 8 and the layer 6 of PEEK carbon filaments, this latter being first deposited on the mold M (left portion of FIG. 5) or lastly (right portion).

The assembly formed by the elements 6-7-8 or 6-7-7a-8 constitutes a monolithic resistive layer which ensures the transfer of aerodynamic and inertial forces as well as those that may be connected with the application in question, such as the nacelles of jet engines, in the same manner as in the preceding examples, using thermosetting composite materials.

It is to be noted that the use of the PEI resin is also to be recommended according to the invention with a resin for impregnation of the structural reinforcing fibers of the polyphenylenesulfone type.

Generally speaking, the reinforcement of the structural strength of the reinforcing layer, according to the invention, is such that in the case of a filamentary deposition of filaments, it is possible to reinforce only one filament out of two, which permits, whilst ensuring the structural strength of the reinforcing layer, having a cost and production time similar to those for the production of conventional panels.

Of course, all the combinations of production of the panels are possible, such as filamentary deposition, deposition of strips (superposed or not) or of panels, perforation of the layer of carbon fibers or the like before or after deposition on the mold, etc. . . .

In FIG. 6, there is shown an embodiment permitting improving the qualities of overall adherence between the composite material, when it is carbon fibers impregnated with a PEEK resin, and the metallic cloth constituted particularly by stainless steel.

Generally speaking, it is not known how to produce layers of carbon fibers impregnated with PEEK resin, other than in roving, which is to say with fibers oriented in the same direction. A strip produced of this material thus has less transverse resistance. For example, to perforate this strip with holes to obtain the desired quantity of surface, the fibers space themselves apart, which renders difficult the control of this quantity.

To overcome this drawback, there is used a thin layer of cloth of glass fibers impregnated with PEI resin, interleaved between the composite material and the dissipating layer constituted by the metallic cloth.

FIG. 6 shows at 6′ a layer of structural reinforcement formed by a unidirectional roving of carbon fibers impregnated with PEEK resin, at 8 a metallic cloth, and, between these two elements, a complex C formed by a thin cloth of glass fibers V clad on opposite sides with a film P of PEI resin.

The complex C is produced before emplacement by superposition in the mold of the three components 6′, C, P, in those order or in the reverse order.

As a modification, the film P of PEI resin can be clad on only a single surface with the glass fiber V.

During the polymerization phase, the PEI resin will migrate between the glass fibers and adhere to the metallic cloth 8 and to the layer 6′ of fibers of carbon impregnated with PEEK resin.

Covering the two surfaces of the cloth V of PEI resin permits increasing the quantity of resin and improving the quality of the bond between the components 6′ and 8, as well as the mechanical resistance of the assembly.

This embodiment is analogous to that of FIG. 3, with the difference that the PEI resin 7 is present in a greater quantity thanks to the presence of a glass cloth.

The increase in the quantity of PEI improves the adherence, however the presence of the glass cloth V imports transverse resistance to the structural reinforcing layer 6′ formed of unidirectional fibers.

Finally, in FIG. 7 are assembled the results of tests of peeling according to the Bell method of characterization, showing the effectiveness of the combination of PEEK resin+PEI resin.

The ordinates of the graph show the unit force in N/mm.

FIG. 7 shows at 10 the strength of an acoustically resistive layer with a double structural component of composite and acoustic material of metal cloth with a cloth/structural reinforcing connection provided only by the thermosetting resin of the composite material. At 11 is shown the strength of a layer with two components connected only with the thermoplastic resin PEEK. At 12 is shown the strength of a layer with two components connected by the association of the thermoplastic resin PEEK of the composite material and the resin PEI that preliminarily clads this composite material.

At 13 is shown the strength of a layer with two connected components with the association of the thermoplastic resin PEEK of the composite material clad in situ by calendering a film of PEI resin, which permits obtaining the best results as to adherence, as can be seen.

Reference numerals 14 and 15 respectively relating to examples 12 and 13 indicate the reduced mechanical strength of the acoustically resistive layers of panels tested in the presence of a flow of aggressive fluid.

Thus, in the case of exposure of the acoustic panel to an aggressive fluid, the PEI resin loses about 50% of its adherence characteristics, but the resistance to unsticking remains greater than that obtained with the techniques previously employed. Thus, the combination PEEK+PEI film remains about 4 times more resistant than a connection produced with a thermosetting resin and about 2.5 times more resistant than a connection produced with a composite thermoplastic material using only the PEEK resin.

1. A process for the production of a reinforced acoustically resistive layer comprising the steps of:
producing a layer of structural reinforcement from fibers pre-impregnated with a thermosetting resin consisting of epoxy resin, said layer having a given quantity of open surface relative to the acoustic waves to be handled,
emplacing on said layer a metallic acoustic cloth whose mesh is adapted to the quantity of open surface of said structural layer, and
polymerizing or consolidating said resin under suitable pressure and temperature,
wherein said process further comprises the step of:
interposing before polymerizing and consolidating, between said resin and said metallic cloth, a component consisting of phenolic nitrile resin adapted for macromolecular interpenetration with said epoxy resin during polymerization or consolidation and that increases the mechanical and adhesive properties of the connection between the fibers of said structural reinforcement and said metallic cloth.

2. Process according to claim 1, wherein said component adapted to reinforce the mechanical adhesive properties is an adhesive material with elastic properties.

3. Process according to claim 1, wherein the fibers pre-impregnated with a thermosetting resin are, before producing said layer of structural reinforcement, subjected to immersion in a bath containing said component consisting of phenolic nitrile resin adapted to reinforce the mechanical and adhesive properties.

4. Process according to claim 1, wherein said component is emplaced by deposition of a film.

5. Process according to claim 4, wherein said film is deposited on at least one surface of a glass cloth interposed between said structural reinforcement and said metallic cloth.

6. A process for the production of a reinforced acoustically resistive layer comprising the steps of:
producing a layer of structural reinforcement from fibers pre-impregnated with a thermoplastic resin consisting of polyetheretherketone resin or polyphenylenesulfone resin, said layer having a given quantity of open surface relative to the acoustic waves to be handled,
emplacing on said layer a metallic acoustic cloth whose mesh is adapted to the quantity of open surface of said structural layer; and
polymerizing or consolidating said resin under suitable pressure and temperature,
wherein said process further comprises the step of:
interposing before polymerizing and consolidating, between said thermoplastic resin and metallic cloth, a component consisting of polyethermide resin adapted for macromolecular interpenetration with said thermoplastic resin during polymerization or consolidation and that increases the mechanical and adhesive properties of the connection between the fibers of said structural reinforcement and said metallic cloth.

7. Process according to claim 6, wherein the fibers pre-impregnated with a thermoplastic resin are, before producing said layer of structural reinforcement, subjected to immersion in a bath containing said component consisting of polyetherimide resin adapted to reinforce the mechanical and adhesive properties.

8. Process according to claim 6, wherein said component is emplaced by deposition of a film.

9. Process according to claim 8, wherein said film is deposited on at least one surface of a glass cloth interposed between said structural reinforcement and said metallic cloth.

10. A process for the production of a reinforced acoustically resistive layer comprising the steps of:
producing a layer of structural reinforcement from fibers pre-impregnated with a thermosetting resin, consisting of epoxy resin, said layer having a given quantity of open surface relative to the acoustic waves to be handled,
emplacing on said layer a metallic acoustic cloth whose mesh is adapted to the quantity of open surface of said structural layer, and
polymerizing or consolidating said resin under suitable pressure and temperature,
wherein said process further comprises the step of:
emplacing on said metallic cloth, before polymerizing or consolidating, a film made of a component consisting of phenolic nitrile resin adapted for macromolecular interpenetration with said thermosetting resin during polymerization or consolidation and that increases the mechanical and adhesive properties of the connection between the fibers of said structural reinforcement and said metallic cloth.

11. Process according to claim 10, wherein the components of the acoustically resistive layer are made and emplaced as follows:
deposition of a film of said component on at least one surface of a glass cloth, then
emplacement by winding or draping on a mold in the following order or the reverse order:
deposition of the composite material
deposition of said glass cloth coated with the film or films,
deposition of the metallic cloth.

12. Process according to claim 10, wherein between the metallic cloth and the structure reinforcement is deposited a second film of said component.

13. A process for the production of a reinforced acoustically resistive layer comprising the steps of.
Producing a layer of structural reinforcement from fibers pre-impregnated with a thermoplastic resin consisting of polyetheretherketone resin or polyphenylenesulfone resin, said layer having a given quantity of open surface relative to the acoustic waves to be handled,
Emplacing on said layer metallic acoustic cloth whose mesh is adapted to the quantity of open surface of said structural layer, and
Polymerizing or consolidating said resin under suitable pressure and temperature,
Wherein said process further comprises the step of:
Emplacing on said metallic cloth, before polymerizing or consolidating, a film made of a component consisting of polyetherimide resin adapted for macromolecular interpenetration with said thermoplastic resin during polymerization or consolidation and that increases the mechanical and adhesive properties of the connection between the fibers of said structural reinforcement and said metallic cloth.

14. Process according to claim 13, wherein between the metallic cloth and the structure reinforcement is deposited a second film of said component.
